(19) United States
(12) Patent Application Publication
(10) Pub. No.: US 2022/0061281 A1
(43) Pub. Date: Mar. 3, 2022

(54) Link Fishing Lure Systems and Methods

(71) Applicant: Michele Trammell, Azle, TX (US)

(72) Inventor: Michele Trammell, Azle, TX (US)

(21) Appl. No.: 17/007,853

(22) Filed: Aug. 31, 2020

(51) Int. Cl. A01K 85/18; A01K 85/01

(52) U.S. Cl. CPC A01K 85/18; A01K 85/01

(57) ABSTRACT

A link fishing lure system may provide an interchangeable lure that may be used in many fishing conditions. The link fishing lure system may contain an enclosure with a channel that may house a connecting link. The link fishing lure system may contain the connecting link within the channel. The connecting link of the link fishing lure system may be secured within the channel when an attachment is coupled to the connecting link. The link fishing lure system may contain an eye canal that extends through the enclosure, intersects the channel, and is operable to house an eye capsule. The eye capsule of the link fishing lure system may be secured within the eye canal when the connecting link is secured within the channel. The link fishing lure system may contain a weighting compartment. The connecting link of the link fishing lure system may be slidably moveable within the channel.

### TECHNICAL FIELD

The present disclosure relates to fishing equipment, and more particularly to fishing lure systems and methods of creating custom fishing lures.

### BACKGROUND

Fishing lures may be used to catch fish effectively. Fishermen typically bring many different types of fishing lures on fishing expeditions in order to effectively fish for different types of fish in different conditions. When using fishing lures on a fishing expedition, fishermen are typically limited to fishing effectively in conditions that the fishing lures that they brought were designed for. If any component of these conventional fishing lures breaks, often the entire conventional lure is discarded.

### SUMMARY

In accordance with one aspect of the present disclosure, a link fishing lure system is provided which allows a fisherman to customize a fishing lure for different fishing conditions using various enclosures, connecting links, eye capsules, and attachments. This may enable fishermen to carry less lures on fishing expeditions. In some implementations, the link fishing lure system may allow for replacement of attachments, enclosures, connecting links, and eye capsules. When part of the link fishing lure system breaks—such as an attachment, enclosure, connecting link, or eye capsule—the broken part of the link fishing lure system may be replaced. The user may also interchange lure attachments.

In some implementations, the link fishing lure system may include a channel that extends through the enclosure. The channel may be operable to removably house a connecting link comprising a plurality of ends. When housed within the channel, the connecting link of the link fishing lure system may be secured within the channel when an attachment is coupled to at least one of the connecting link's ends.

In some implementations, the link fishing lure system may include an enclosure comprising a channel operable to house a connecting link. The connecting link may be secured within the enclosure when an attachment is coupled to the connecting link. The link fishing lure system may contain a means for connecting an attachment. The means for connecting may be removably disposed within the channel.

In some implementations, the connecting link may be shaped like an open geometric stadium. In some implementations, the connecting link may have at least one end shaped like an open figure eight. In some implementations, the connecting link may have an opening. In some implementations, the enclosure may be shaped like part of a fish. In some implementations, the connecting link may be slidably moveable within the channel. In some implementations, the enclosure may contain a weighting compartment operable to house a weight. In some implementations, an eye canal, which may be operable to house an eye capsule, may extend through the enclosure and intersect the channel. In some implementations, the eye capsule may be secured within the eye canal when the connecting link is inserted into the channel and secured within the enclosure. In some implementations, the link fishing lure system may contain a means for producing sound when the system is in use.

The details of one or more implementations are set forth in the accompanying drawings and the description below. Other features, objects, and advantages of the implementations will be apparent from the description and drawings.

### BRIEF DESCRIPTION OF FIGURES

For a more complete understanding of this disclosure and its features, reference is now made to the following description, taken in conjunction with the accompanying drawings, in which:

FIG. 1 illustrates an exploded perspective view of a link fishing lure system according to the present disclosure.

FIG. 2 illustrates an exploded side view of the link fishing lure system of FIG. 1.

FIG. 3 illustrates an end view of the back of an enclosure of the link fishing lure system of FIG. 1.

FIG. 4 illustrates an exploded perspective view of the link fishing lure system of FIG. 1 with attachments.

FIG. 5 illustrates a perspective view of another implementation of a link fishing lure system according to the present disclosure.

FIG. 6 illustrates an exploded perspective view of yet another implementation of a link fishing lure system with a connecting link that has an end shaped like an open figure eight according to the present disclosure.

FIG. 7a illustrates an exploded perspective view of yet another implementation of a link fishing lure system with a channel that can accept a connecting link in multiple planes within the enclosure according to the present disclosure.

FIG. 7b illustrates an exploded perspective view of yet another implementation of a link fishing lure system with a channel that can accept a connecting link in multiple planes within the enclosure according to the present disclosure.

FIG. 8a illustrates an implementation of a connecting link with an end that has an opening loop that can couple an attachment when the user exerts pressure on the opening loop.

FIG. 8b illustrates another implementation of a connecting link with an end shaped like an open figure eight.

FIG. 8c illustrates yet another implementation of a connecting link shaped like a geometric stadium with an opening.

FIG. 8d illustrates still another implementation of a connecting link shaped like a geometric stadium with an opening having angled ends.

FIG. 8e illustrates yet another implementation of a connecting link shaped like a geometric stadium with no openings and an integrated hook at an end.

FIG. 8f illustrates still another implementation of a connecting link shaped like a geometric stadium with an opening and a weight securing prong.

FIG. 8g illustrates yet another implementation of a connecting link with six ends.

FIG. 9 illustrates an exploded perspective view of yet another implementation of a link fishing lure system with a connecting link with a weight securing prong and a channel that can accept a connecting link in multiple planes within the enclosure according to the present disclosure.

FIG. 10 illustrates an exploded perspective view of yet another implementation of a link fishing lure system with a three-dimensional connecting link according to the present disclosure.

FIG. 11 illustrates an end view of the back of an enclosure of a link fishing lure system with both a connecting link channel and an eye canal according to the present disclosure.

FIG. 12 illustrates an exploded side view of the link fishing lure system of FIG. 11.

FIG. 13 illustrates an exploded perspective view of a link fishing lure system with an eye canal and an eye capsule with rattles according to the present disclosure.

FIG. 14 illustrates an exploded perspective view of a link fishing lure system with an eye canal and an eye capsule with rattling eyes according to the present disclosure.

FIG. 15 illustrates an exploded perspective view of a link fishing lure system with an eye canal and a dumbbell eye capsule according to the present disclosure.

FIG. 16a illustrates an implementation of an eye capsule with rattles.

FIG. 16b illustrates an implementation of an eye capsule with rattles and a wall.

FIG. 16c illustrates an implementation of an eye capsule with rattling eyes.

FIG. 16d illustrates an implementation of a dumbbell eye capsule.

### DETAILED DESCRIPTION

Implementations of the present disclosure generally provide a link fishing lure systems and methods for creating a custom fishing lure. When parts of the link fishing lure system break, users may replace the individual broken components instead of replacing the entire link fishing lure system. The link fishing lure system may enable users to create customized lures using various attachments that may be adapted for specific fishing conditions and for catching specific species of fish. The customizability of the link fishing lure system may allow users to use less fishing lure equipment.

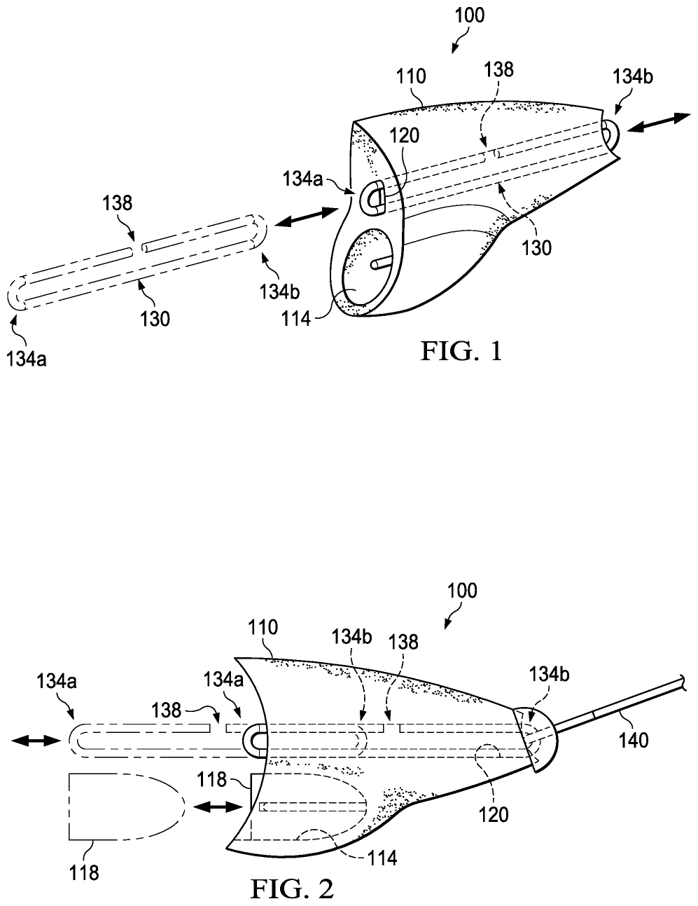

FIG. 1 illustrates one implementation of a link fishing lure system 100 with no attachments coupled to the link fishing lure system 100. As illustrated in FIG. 1, a link fishing lure system 100 comprises an enclosure 110 with a channel 120 operable to removably house a connecting link 130. The enclosure 110 forms the exterior portion of the fishing lure and may generally be shaped like part of a fish, such as a fish head and/or a fish body. The enclosure 110 may optionally contain a weighting compartment 114 that houses a weight 118. The channel 120 may extend through the interior of the enclosure 110 and along its entire length. The connecting link 130 may comprise a body 132 with ends 134a, 134b, and an opening 138 in the body 130. In the implementation shown in FIG. 1, the body 132 of the connecting link 130 is shaped like a long oval, also referred to as an open geometric stadium, such that the ends 134a, 134b of the connecting link 130 are shaped like half circles coupled to substantially straight segments 131, 133 of the body 132. In various implementations, the optional opening 138 in the body 132 may be positioned on either of the substantially straight segments 131, 133, anywhere along the portion where the segments 131, 133 will be positioned within the channel 120 when the connecting link 130 is housed within the enclosure 110.

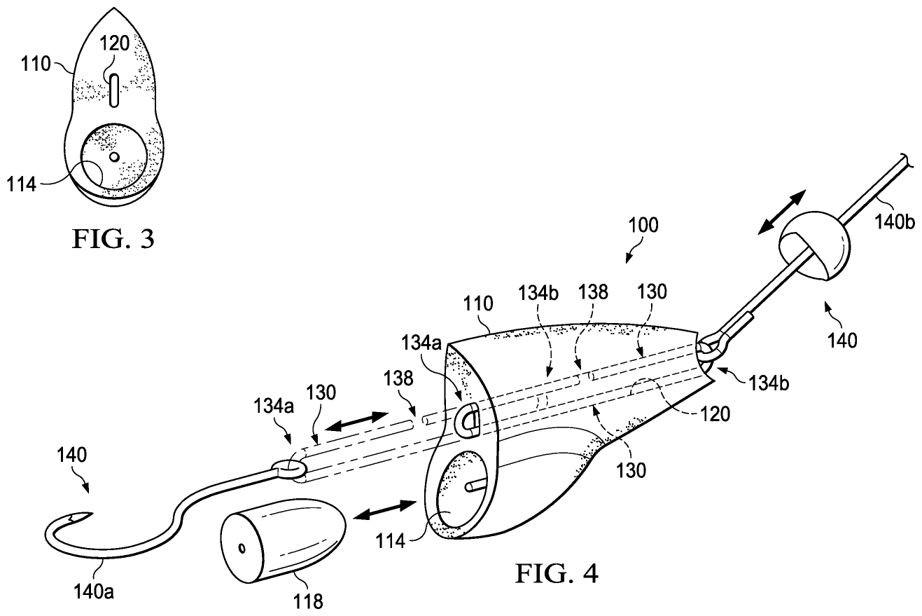

FIG. 2 illustrates a side view of the link fishing lure system 100 of FIG. 1. When the connecting link 130 is slid into the channel 120, the connecting link 130 may protrude past the enclosure 110 on both ends 134a-b of the connecting link. FIG. 3 illustrates a back view of the enclosure 110 of FIG. 1. The channel 120 has dimensions sufficient to slide the connecting link 130 into the channel 120. The weighting compartment 114 has dimensions sufficient to house a weight 118.

FIG. 4 illustrates the link fishing lure system 100 of FIG. 1 with attachments 140. The attachments 140 may have a variety of coupling mechanisms, including clip-on or eye style attachments. Clip-on attachments 140 can couple to the connecting link 130 without requiring an opening 138 in the connecting link 130. Clip-on attachments 140 have temporary openings in their coupling mechanism that allows the clip-on attachment to couple to the connecting link 130. A clip-on attachment 140 can be coupled directly on an end 134a-b of the connecting link 130 or can be threaded through the opening 138 in the connecting link 130. Eye attachments 140 have no temporary openings in their coupling mechanism that allows the attachment to couple to the connecting link. Therefore, eye attachments 140 require an opening 138 in the connecting link 130 to couple to the connecting link 130. An eye attachment 140 can be coupled to the connecting link 130 by threading the eye of the attachment through the opening 138 in the connecting link 130.

In an implementation, the connecting link 130 is secured within the channel 120 of the enclosure 110 by coupling one or more attachments 140 to one or more of the ends 134a, 134b of the connecting link 130. The connecting link is secured within a channel of the enclosure when the design of the channel and connecting link, along with one or more attachments coupled at the ends of the connecting link, cause the connecting link to be irremovably positioned within the channel and enclosure when a force—which is insufficient to cause damage to the connecting link, channel, enclosure, or attachment—is applied to any or multiple ends of the connecting link. Depending on the coupling mechanism of the attachments 140, the attachments 140 can be coupled to the connecting link 130 by coupling directly to the ends 134a, 134b of the connecting link 130 or the attachments 140 can be threaded through the opening 138 in the connecting link 130. If an implementation of the connecting link 130 omits an opening 138 in the body 132, then clip-on attachments 140 may be used to secure the connecting link 130 within the channel 120 of the enclosure 110.

In one implementation, the connecting link 130 in the fishing lure system 100 illustrated in FIG. 4 may be secured by first threading an attachment 140, such as attachment 140a, through the opening 138 in the connecting link 130 until the attachment 140a reaches end 134a. The opposite end 134b of the connecting link 130 without an attachment 140 may then be inserted into the channel 120 until the end 134b of the connecting link 130 without an attachment 140 protrudes past the enclosure 110. An end 134a-b of the connecting link 130 protrudes past the enclosure 110 when the end 134a-b is not prohibited by the enclosure 110 from coupling to an attachment 140. A clip-on attachment 140, such as attachment 140b, may then be coupled to the opposite end 134b of the connecting link 130 without an attachment 140. Once an attachment 140, such as attachment 140a and attachment 140b, is coupled to each end 134a-b of the connecting link 130, the connecting link 130 is secured within the channel 120 and within the enclosure 110.

In another implementation, the connecting link 130 in the fishing lure system 100 illustrated in FIG. 4 may be secured by inserting the connecting link 130 into the channel 120 until the leading end 134b of the connecting link 130 protrudes past the enclosure 110. Clip-on attachments 140 may then be coupled to both ends 134a-b of the connecting link 130. Once an attachment 140 is coupled to each end 134a-b of the connecting link 130, the connecting link 130 is secured within the channel 120 and within the enclosure 110.

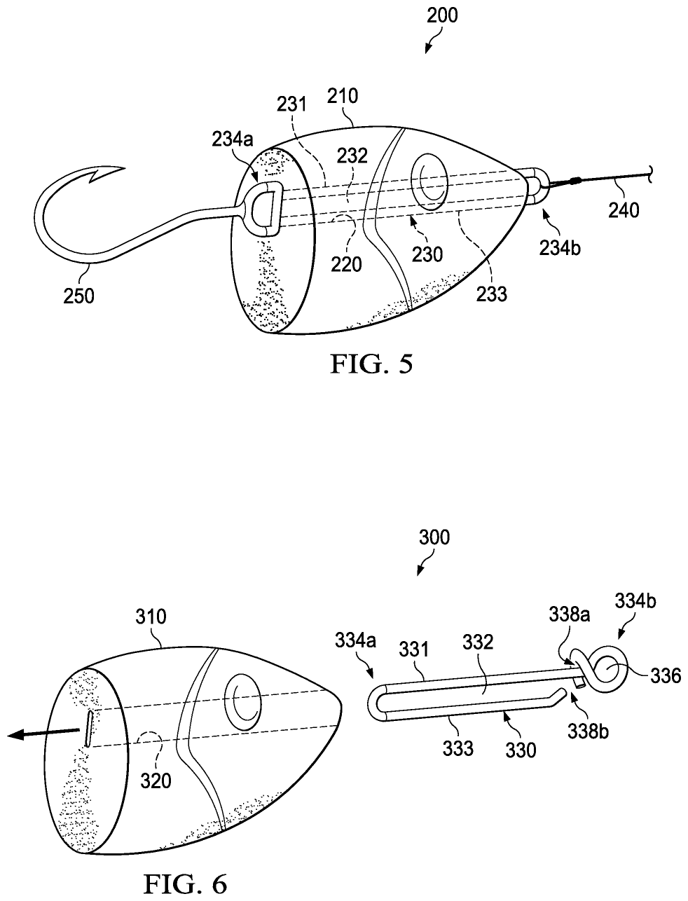

FIG. 5 illustrates another implementation of a link fishing lure system 200 comprising an enclosure 210, a channel 220, and a connecting link 230. In an implementation, the connecting link 230 contains no openings and includes an integrated hook 250 at an end 234a of the connecting link 230. The end 234a of the connecting link 230 with an integrated hook 250 is larger than the channel 220. The opposite end 234b and at least part of the body 232 of the connecting link 230 is sized to fit through the channel 220.

The connecting link 230 in the fishing lure system 200 illustrated in FIG. 5 may be secured by inserting the end 234b of the connecting link 230 without an integrated hook 250 into the channel 220 until the end 234b of the connecting link 230 protrudes past the enclosure 210. Once a clip-on attachment 240 is coupled to the end 234b of the connecting link 230, the connecting link 230 is secured within the channel 220 and within the enclosure 210.

FIG. 6 illustrates yet another implementation of a link fishing lure system 300 comprising an enclosure 310, a channel 320 and a connecting link 330. The connecting link 330 comprises a body 332 with substantially straight segments 331, 333 extending between and coupling to an end 334a that forms a half circle and an end 334b that forms an open figure eight 336. The connecting link 330 contains two openings 338a, 338b. One opening 338a is in the open figure eight 336 and the other opening 338b is on substantially straight segment 333, adjacent to the open figure eight 336. In this implementation of the connection link 332, both openings 338a, 338b may couple eye-style or clip-on attachments by threading. The channel 320 is shaped to allow the connecting link 330 to be inserted from either end of the channel 320.

The connecting link 330 in the fishing lure system 300 illustrated in FIG. 6 may be secured by first threading an attachment through one of the openings 338a, 338b in the connecting link 330 until the attachment reaches one end 334a. Alternatively, a clip-on attachment may be coupled directly on the end 334a. The opposite end 334b of the connecting link 330 may then be inserted into the channel 320 until the end 334b of the connecting link 330 protrudes past the enclosure 310. A clip-on attachment may then be coupled to the end 334b of the connecting link 330. Alternatively, an eye-style or clip-on attachment may be threaded through the opening 338a in the open figure eight 336. Once an attachment is coupled to each end 334a, 334b of the connecting link 330, the connecting link 330 is secured within the channel 320 and within the enclosure 310.

The connecting link 330 in the fishing lure system 300 illustrated in FIG. 6 may be secured by inserting an end 334a-b of the connecting link into the channel 320 until the end 334a-b of the connecting link 330 protrudes past the enclosure 310. A clip-on attachment may then be coupled to one end 334a of the connecting link 330. Another clip-on attachment may be coupled to the opposite end 334b of the connecting link 330, or the attachment may be threaded on the opposite end 334b of the connecting link 330 via opening 338a in the open FIG. 336. Once an attachment is coupled to each end 334a, 334b of the connecting link 330, the connecting link 330 is secured within the channel 320 and within the enclosure 310.

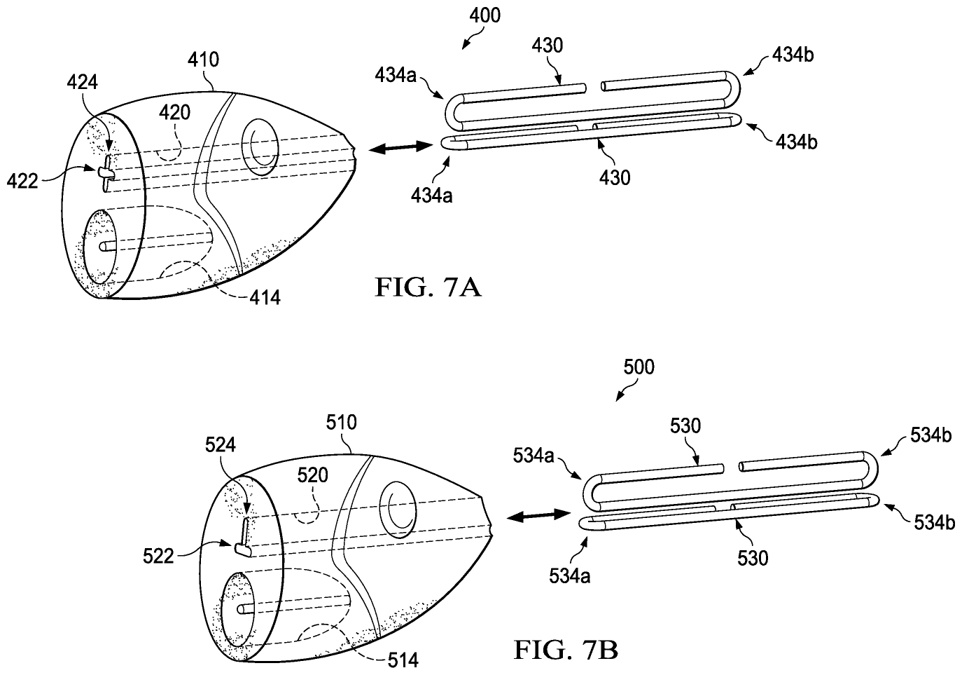

FIGS. 7a and 7b illustrate additional implementations of link fishing lure systems 400, 500, wherein the channel 420, 520 in the enclosure 410, 510 in the fishing lure system 400, 500 may accept a connecting link 430, 530 in multiple planes within the enclosure 410, 510. As shown in FIG. 7a, the channel 420 may be formed in the shape of a cross having a horizontal part 422 and a vertical part 424. Similarly, as shown in FIG. 7b, the channel 520 may be formed in the shape of an inverted T with a horizontal part 522 and a vertical part 524. In various implementations, the shapes of the channels 420, 520 may allow the connecting links 430, 530 to enter the horizontal parts 422, 522 of the channel 420, 520 or the vertical parts 424, 524 of the channel 420, 520. In other implementations, the channels may include parts that occur at angles that are not horizontal or vertical. This versatility may allow the link fishing lure system to adjust to the attachments available to a user.

The connecting links 430, 530 in the fishing lure systems 400, 500 illustrated in FIGS. 7a and 7b may be formed like the connecting link 130 shown in FIG. 1 with a long oval body 432, 532 having an opening 438, 538. As such, the connecting links 430, 530 may be secured within either the horizontal part 422, 522 of the channel 420, 520 or within the vertical part 424, 524 of the channel 420, 530 using attachments in the various manners described above with respect to FIG. 4. Once an attachment is coupled to each end 434a-b, 534a-b of the connecting link 430, 530, the connecting link 430, 530 is secured within the horizontal part 422, 522 of the channel 420, 520 or within the vertical part 424, 524 of the channel 420, 530 and within the enclosure 410, 510.

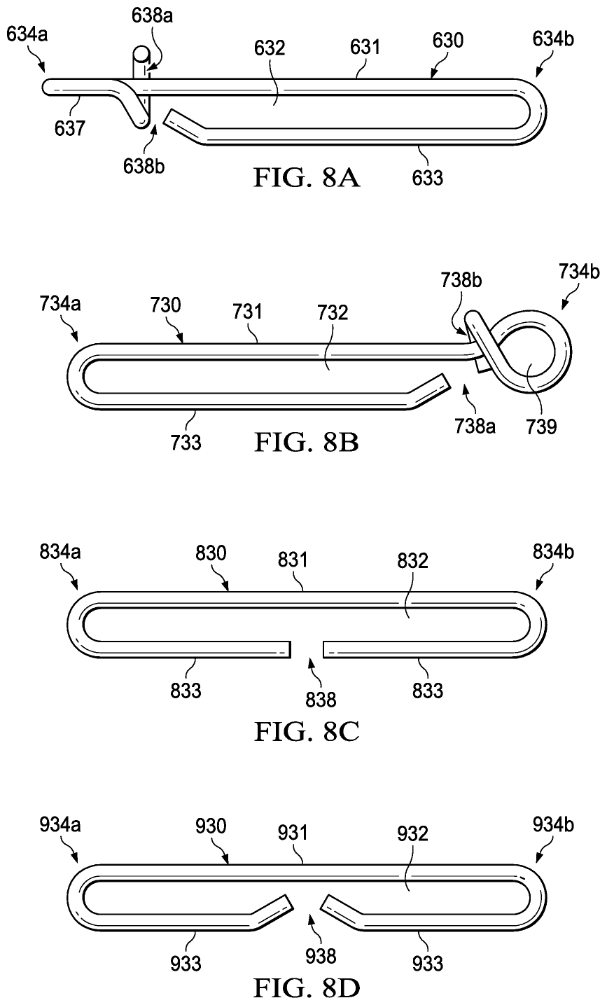

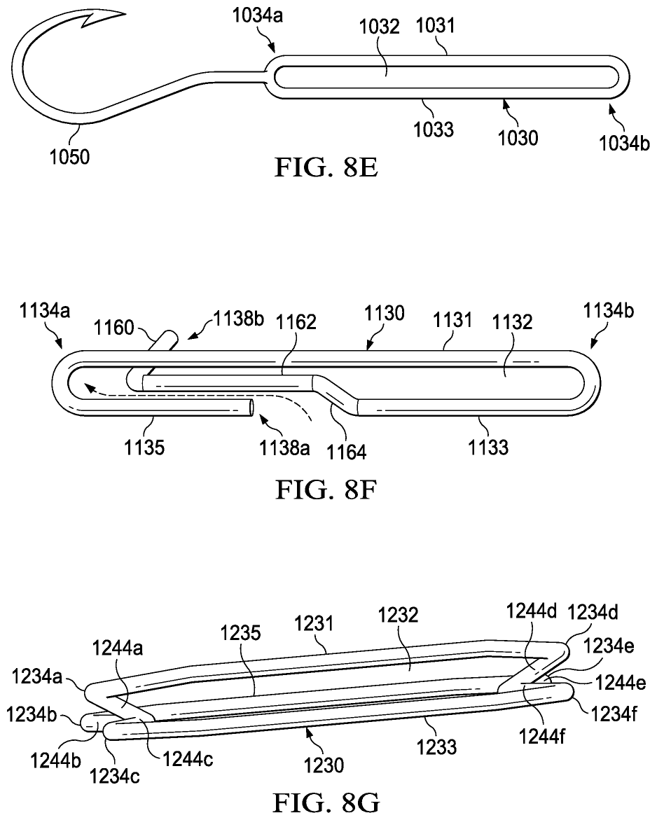

FIGS. 8a, 8b, 8c, 8d, 8e, 8f, and 8g illustrate several additional implementations of connecting links 630, 730, 830, 930, 1030, 1130. Whether an attachment can be threaded or clipped on to the connecting link 630, 730, 830, 930, 1030, 1130 is dependent on the geometry of the connecting link 630, 730, 830, 930, 1030, 1130 itself and the corresponding channel in the fishing lure system.

In the implementation of the connecting link 630 of FIG. 8a, the connecting link 630 comprises two substantially straight segments 631, 633, an opening loop 637 on an end 634a, a curved end 634b, and two openings 638a, 638b. Thus, the connecting link 630 contains two openings 638a, 638b in the body 632 where an attachment can be coupled. The first opening 638a is in the opening loop 637 and the second opening 638b is on substantially straight segment 633 near the opening loop 637. The openings 638a, 638b allow an eye attachment to be coupled by threading or a clip-on attachment to attach to both ends 634a-b. In the fishing lure system, an eye attachment cannot couple to both ends 634a-b of the connecting link 630 because it is not possible to both couple an eye attachment at each end and secure the connecting link 630 within the channel of the enclosure. The substantially straight segments 631, 633 keep the connecting link 630 secure in the direction perpendicular to the length of the channel. The end 634a creates an opening loop 637 that allows an attachment to slide onto the end 634a by applying slight pressure and opening the opening 638a. Without pressure, the opening loop 637 is pressed against itself to couple the attachment and close the loop on the end 634a.

In the implementation of the connecting link 730 of FIG. 8b, the connecting link 730 comprises two substantially straight segments 731, 733, an open figure eight 739 on an end 734b, a curved end 734a, and two openings 738a, 738b. The first opening 738a is on the substantially straight segment 733 near the open figure eight 739 and the second opening 738b is in the open figure eight 739. The two openings 738a, 738b in the connecting link 730 can couple attachments. The openings 738a, 738b allow an eye attachment to be coupled by threading or a clip-on attachment to attach to both ends 734a, 734b. In the fishing lure system, an eye attachment cannot couple to both ends 734a-b of the connecting link 730 because it is not possible to both couple an eye attachment at each end and secure the connecting link 730 within the channel of the enclosure. The substantially straight segments 731, 733 keep the connecting link 730 secure in directions along a plane perpendicular to the channel to the channel. The end 734b creates an open figure eight 739 that allows an attachment to slide onto the end 734b by applying slight pressure and opening the opening 738b in the open figure eight 739. Without pressure, the open figure eight 739 is pressed against itself to couple the attachment and close the open figure eight 739 on the end 734b.

In the implementation of the connecting link 830 of FIG. 8c, the connecting link 830 comprises two substantially straight segments 831, 833, two curved ends 834a, 834b, and one opening 838. The opening 838 is approximately in the middle of substantially straight segment 833, and an attachment can be coupled to either end 834a, 834b through the opening 838. The opening 838 allows an eye attachment to be coupled by threading, or clip-on attachments may be attached at either end 834a, 834b. In a fishing lure system, an eye attachment cannot couple to both ends 834a-b of the connecting link 830 because it is not possible to both couple an eye attachment at each end and secure the connecting link 830 within the channel of the enclosure. The substantially straight segments 831, 833 keep the connecting link 830 secure in the direction perpendicular to the channel.

In the implementation of the connecting link 930 of FIG. 8d, the connecting link 930 comprises two substantially straight segments 931, 933, two curved ends 934a, 934b, and one angled opening 938. The opening 938 is approximately in the middle of the substantially straight segment 933, and an attachment can be coupled to either end 934a, 934b through the opening 938. The substantially straight segment 933 is angled inward at both ends of the opening 938 to reduce the possibility of an attachment coupled to the connecting link 930 from uncoupling when the connecting link 930 is not within the channel 920. The opening 938 allows an eye attachment to be coupled by threading, or clip-on attachments may be attached at either end 934a, 934b. In a fishing lure system, an eye attachment cannot couple to both ends 934a, 934b of the connecting link 930 because it is not possible to both couple an eye attachment at each end and secure the connecting link 940 within the channel of the enclosure. The substantially straight segments 931, 933 keep the connecting link 930 secure in the direction perpendicular to the channel.

In the implementation of the connecting link 1030 of FIG. 8e, the connecting link 1030 comprises two substantially straight segments 1031, 1033, two curved ends 1034a, 1034b, and an integrated hook 1050. The integrated hook 1050 is located on an end 1034a, 1034b of the connecting link, such as end 1034a as shown in FIG. 8e. A clip-on attachment may be coupled on either end 1034a, 1034b, including the end 1034a with the integrated hook 1050. If an end 1034a is bigger than the channel, the connecting link 1030 may be secured within the channel by coupling an attachment at the other end 1034b. If an end 1034a is not bigger than the channel, the connecting link 1030 may be secured within the channel by coupling an attachment at both ends 1034a, 1034b. The substantially straight segments 1031, 1033 keep the connecting link 1030 secure in the direction perpendicular to the channel.

In the implementation of the connecting link 1130 of FIG. 8f, the connecting link 1130 comprises three substantially straight segments 1131, 1133, 1135, a weight securing prong 1160, a straight internal segment 1162, a bent segment 1164, and two openings 1138a, 1138b. The bent segment 1164 is coupled between substantially straight segment 1133 and straight internal segment 1162, to which the weight securing prong 1160 is coupled. The first opening 1138a is on the substantially straight segment 1135 and the second opening 1138b is on the weight securing prong 1160. The two openings 1138a, 1138b in the connecting link 1130 can couple attachments. In a fishing lure system, the openings 1138a, 1138b allow an eye attachment to be coupled to an end 1134a by threading or a clip-on attachment to attach to both ends 1134a, 1134b. In a fishing lure system, an eye attachment cannot couple to an end 1134b of the connecting link 1130 because it is not possible to both couple an eye attachment at the end 1134b and secure the connecting link 1130 within the channel of the enclosure. The substantially straight segments 1131, 1133, 1135 keep the connecting link 1130 secure in directions along a plane perpendicular to the channel. When the connecting link is secured within an enclosure, the weight securing prong 1160 extends across and blocks the weighting compartment to secure a weight within the weighting compartment. When the weight securing prong 1160 does not block the weighting compartment, the user may adjust the weight in the weighting compartment.

In the implementation of the connecting link 1230 of FIG. 8g, the connecting link 1230 comprises three substantially straight segments 1231, 1233, 1235 that are not all in the same plane, six angled segments 1232a, 1232b, 1232c, 1232d, 1232e, 1232f that couple the straight segments 1231, 1233, 1235 to one another, and six ends 1234a, 1234b, 1234c, 1234d, 1234e, 1234f, each positioned between a straight segment and an angled segment 1244a, 1244b, 1244c, 1244d, 1244e, 1244f. A clip-on attachment may be coupled to any end 1234a, 1234b, 1234c, 1234d, 1234e, 1234f. The connecting link 1230 may be secured within a channel by both coupling one or more attachments at one or more of the ends within a set of ends 1234a, 1234b, 1234c and by coupling one or more attachments at one or more of the ends within a second set of ends 1234d, 1234e, 1234f. The substantially straight segments 1231, 1233, 1235 keep the connecting link 1230 secure in the direction perpendicular to the channel.

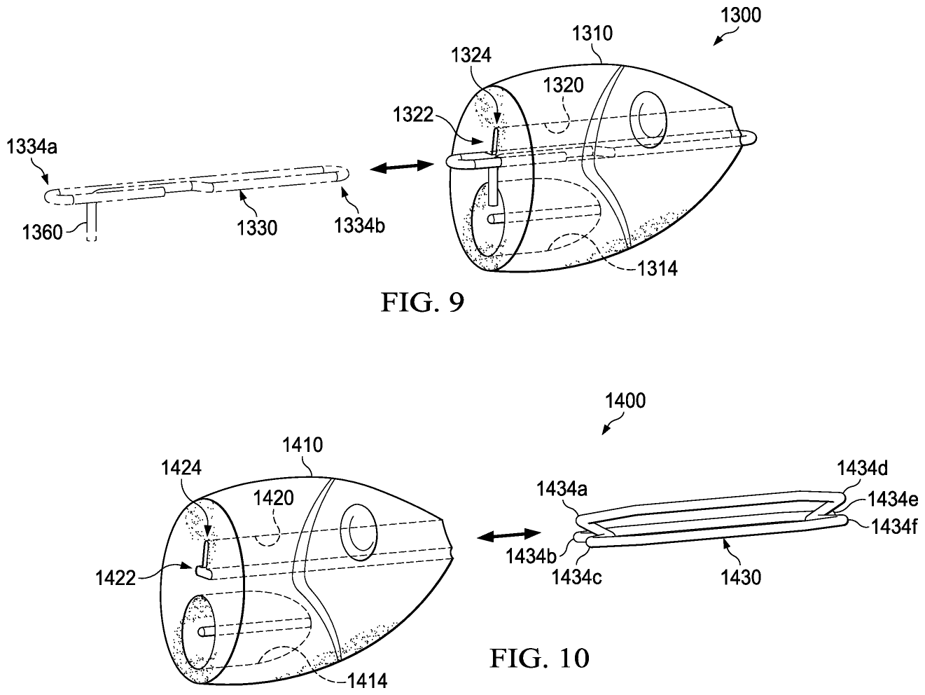

FIG. 9 illustrates yet another implementation of a link fishing lure system 1300 comprising an enclosure 1310, a channel 1320 comprising a horizontal part 1322 and a vertical part 1324, a connecting link 1330, and a weighting compartment 1314. The connecting link 1330 includes a weight securing prong 1360. When the connecting link 1330 is positioned within the horizontal part 1322 of the channel 1320, the weight securing prong 1360 is operable to both secure a weight within the weighting compartment 1314 and to secure the connecting link 1330 within the enclosure 1310. In this implementation, when the connecting link 1330 is positioned within the vertical part 1324 of the channel 1320, the weight securing prong 1360 is operable to secure the connecting link 1330 within the enclosure 1310 without securing a weight within the weighting compartment 1314.

FIG. 10 illustrates yet another implementation of a link fishing lure system 1400 comprising an enclosure 1410, a channel 1420 comprising a horizontal part 1422 and a vertical part 1424, a connecting link 1430, and a weighting compartment 1414. The connecting link 1430 may be three-dimensional, such as the connecting link 1230 of FIG. 8f, with six ends 1434a, 1434b, 1434c, 1434d, 1434e, 1434f that may couple to a clip-on attachment. The six ends may allow a user to couple multiple attachments on each side of the enclosure without having to couple multiple attachments on a single end. Six ends 1234a, 1234b, 1234c, 1234d, 1234e, 1234f may allow a user to have greater flexibility when configuring a lure. In this implementation, when the connecting link 1430 is positioned within the channel 1420, two of the straight segments extend into the horizontal part 1422 of the channel 1420, while the third straight segment extends into the vertical part 1424 of the channel 1420. The connecting link 1430 may be secured within the channel 1420 by both coupling one or more attachments at one or more of the ends within a set of ends 1434a, 1434b, 1434c and by coupling one or more attachments at one or more of the ends within a second set of ends 1434d, 1434e, 1434f. The substantially straight segments 1431, 1433, 1435 keep the connecting link 1430 secure in the direction perpendicular to the channel.

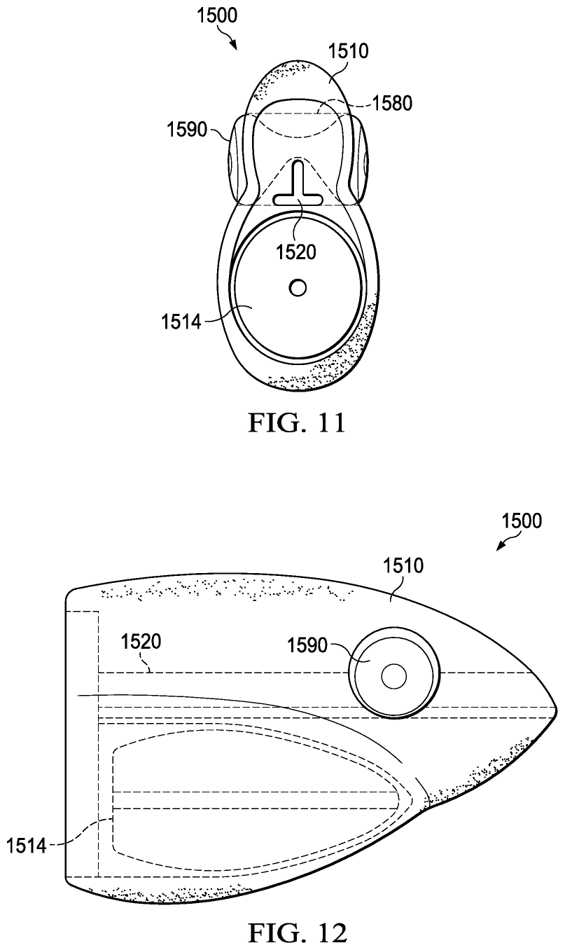

FIG. 11 illustrates a back end view, and FIG. 12 illustrates a side view, of still another implementation of a link fishing lure system 1500 comprising an enclosure 1510, a channel 1520, an optional weighting compartment 1514, an eye canal 1580, and a dumbbell eye capsule 1590 positioned within the eye canal 1580. The optional weighting compartment 1514 may house a weight. The channel 1520 may include a horizontal part 1522 and a vertical part 1524. The channel 1520 may house a connecting link that may be secured within the channel 1520 of the enclosure 1510. In this implementation, both parts 1522, 1524 of the channel 1520 run along the enclosure 1510, substantially perpendicular to the eye canal 1580. In other implementations, the channel 1520 does not run substantially perpendicular to the eye canal 1580. The eye canal 1580 and channel 1520 are connected at an intersection. In the implementation of FIG. 11, the eye canal 1580 has dimensions sufficient to slide the dumbbell eye capsule 1590 into the eye canal 1580. The eye canal 1580 is operable to removably house the dumbbell eye capsule 1590 or another type of eye capsule.

When inside the eye canal 1580, the eye capsule 1590 is positioned to allow a connecting link to be positioned into and secured within the channel 1520 of the enclosure 1510, which also secures the eye capsule 1590 within the eye canal 1580 of the enclosure 1510. The eye capsule 1590 is secured within the eye canal 1580 of the enclosure 1510 when the eye capsule 1590 is not removable from the eye canal 1580 when a force—which is insufficient to cause damage to the eye capsule, eye canal, connecting link, channel, enclosure, or an attachment—is applied to any or multiple ends of the eye capsule 1590.

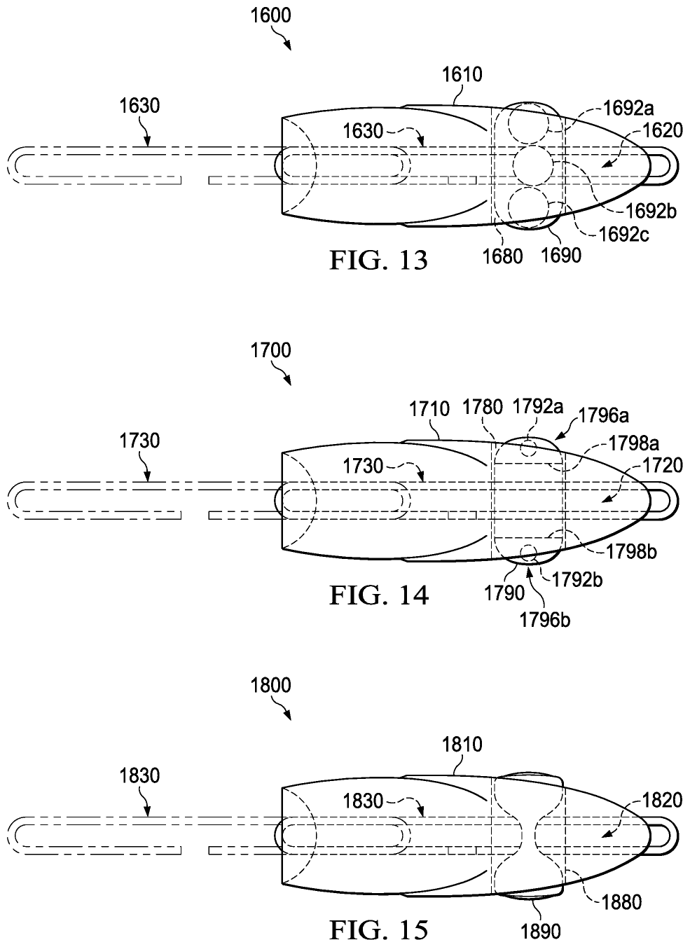

FIG. 13 illustrates a top down view of yet another implementation of a link fishing lure system 1600 comprising an enclosure 1610, a channel 1620, a connecting link 1630, an eye canal 1680, and an eye capsule 1690. The eye capsule 1690 comprises rattles 1692a, 1692b, 1692c that move within the eye capsule 1690 to produce a sound when the link fishing lure system 1600 is in use. In one implementation, the eye capsule 1690 may be secured within the eye canal 1680 of the enclosure 1610 by sliding the eye capsule 1690 into the eye canal 1680, then sliding the connecting link 1630 into the channel 1620, then securing the connecting link 1630 within the enclosure 1610, such as by coupling attachments. Once the connecting link 1630 is secured within the channel 1620, the eye capsule 1690 is also secured within the eye canal 1680.

FIG. 14 illustrates a top down view of still another implementation of a link fishing lure system 1700 comprising an enclosure 1710, a channel 1720, a connecting link 1730, an eye canal 1780, and an eye capsule 1790 with rattling eyes 1796a, 1796b. The eye capsule 1790 comprises rattles 1792a, 1792b that move within the eye capsule 1790 to produce a sound when the link fishing lure system 1700 is in use. The eye walls 1798a, 1798b inside the eye capsule 1790 keep the rattles 1792a, 1792b isolated at the ends of the eye capsule 1790 and create the rattling eyes 1796a, 1796b. The walls 1798a, 1798b may be solid or perforated and may change the sound the eye capsule 1790 creates when the link fishing lure system 1700 is in use. In some implementations, the eye capsule 1790 with rattling eyes 1796a, 1796b may contain one or more additional rattles in the space between the walls 1798a, 1798b. In one implementation, the eye capsule 1790 may be secured within the eye canal 1780 of the enclosure 1710 by sliding the eye capsule 1790 into the eye canal 1780, then sliding the connecting link 1730 into the channel 1720, then securing the connecting link 1730 within the enclosure 1710, such as by coupling attachments. Once the connecting link 1730 is secured within the channel 1720, the eye capsule 1790 is also secured within the eye canal 1780.

FIG. 15 illustrates a top down view of still another implementation of a link fishing lure system 1800 comprising an enclosure 1810, a channel 1820, a connecting link 1830, an eye canal 1880, and a dumbbell eye capsule 1890. The dumbbell eye capsule 1890 may fit tightly or loosely within the eye canal 1880. A dumbbell eye capsule 1890 that fits loosely within the eye canal 1880 may be used to change the sound the eye capsule 1890 creates when the link fishing lure system 1800 is in use. In one implementation, the eye capsule 1890 may be secured within the eye canal 1880 of the enclosure 1810 by sliding the eye capsule 1890 into the eye canal 1880, then sliding the connecting link 1830 into the channel 1820, then securing the connecting link 1830 within the enclosure 1810, such as by coupling attachments. Once the connecting link 1830 is secured within the channel 1820, the eye capsule 1890 is also secured within the eye canal 1880.

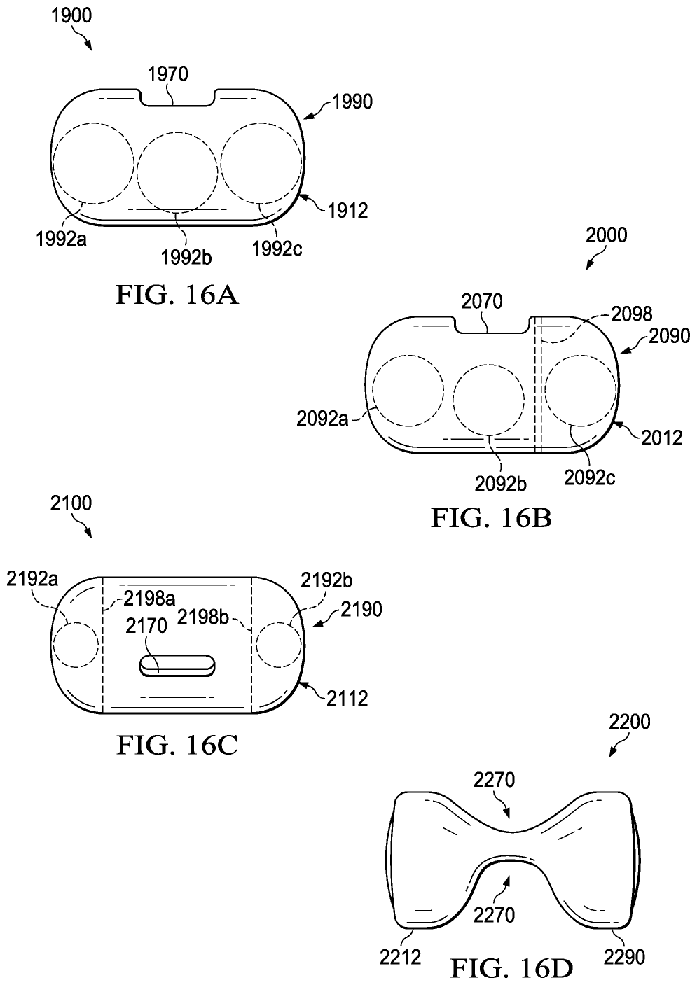

FIGS. 16a, 16b, 16c, and 16d illustrate top down views of several additional implementations of eye capsules 1990, 2090, 2190, 2290. When incorporating each of these eye capsules into a link fishing lure system, the geometry of the channel in the enclosure, the connecting link, the eye canal, and the eye capsule 1990, 2090, 2190, 2290 determines how the eye capsule 1990, 2090, 2190, 2290 should be positioned within the eye canal.

Referring now to FIG. 16a, the eye capsule 1990 comprises a container 1912, a cavity 1970, and rattles 1992a, 1992b, 1992c. The container 1912 houses the rattles 1992a, 1992b, 1992c. The cavity 1970 may allow the connecting link, when inserted into the channel of the enclosure in a specific orientation, to pass in and through the cavity 1970 and eye canal. When the eye capsule 1990 is inserted into the eye canal, the cavity 1970 should be aligned with the channel of the enclosure to allow a connecting link to pass through the portion of the channel common to both the channel and the eye canal. The eye capsule 1990 contains rattles 1992a, 1992b, 1992c that move within the eye capsule 1990 to produce a sound when the link fishing lure system is in use.

Referring now to FIG. 16b, eye capsule 2090 comprises a container 2012, a cavity 2070, a wall 2098, and rattles 2092a, 2092b, 2092c. The container 2012 houses the rattles 2092a, 2092b, 2092c. The wall 2098 is positioned internally of the container 2012 to separate rattle 2092c from the other rattles 2092a, 2092b and maintain each of the rattles 2092a, 2092b, 2092c within a certain portion of the container 2012. In various implementations, the wall 2098 may be positioned at any desired location internally of the container 2012. The cavity 2070 may allow the connecting link, when inserted into the channel of the enclosure in a specific orientation, to pass in and through the cavity 2070 and eye canal. When the eye capsule 2090 is inserted into the eye canal, the cavity 2070 cavity should be aligned with the channel of the enclosure to allow a connecting link to pass through the portion of the channel common to both the channel and the eye canal. The eye capsule 2090 contains rattles 2092a, 2092b, 2092c that move within the eye capsule 2090 to produce a sound when the link fishing lure system is in use. The wall 2098 may be solid or perforated and may change the sound the eye capsule 2090 creates when the link fishing lure system is used.

Referring now to FIG. 16c, eye capsule 2190 comprising a container 2112, a cavity 2170, walls 2198a, 2198b, and rattles 2192a, 2192b. The container 2112 houses the rattles 2192a, 2192b. The walls 2198a, 2198b are positioned internally of the container 2112 to separate the rattles 2192a, 2192b and maintain each of the rattles 2192a, 2192b within a certain portion of the container 2112. In various implementations, the walls 2198a, 2198b may be positioned at any desired location internally of the container 2012. The cavity 2170 may allow the connecting link, when inserted into the channel of the enclosure in a specific orientation, to pass in and through the cavity 2170 and eye canal. When the eye capsule 2190 is inserted into the eye canal, the cavity 2170 should be aligned with the channel of the enclosure to allow a connecting link to pass through the portion of the channel common to both the channel and the eye canal. The eye capsule 2190 contains rattles 2192a, 2192b that move within the eye capsule 2190 to produce a sound when the link fishing lure system is used by a user. The walls 2198a, 2198b may be solid or perforated and may change the sound the eye capsule 2190 creates when the link fishing lure system is in use.

Referring now to FIG. 16d, dumbbell eye capsule 2290 comprises a container 2212 and a cavity 2270. When the dumbbell eye capsule 2290 is inserted into the eye canal, the cavity 2270 should be aligned with the channel of the enclosure to allow a connecting link to pass through the portion of the channel common to both the channel and eye canal. The eye capsule 2290 may fit tightly or loosely within the eye canal. A dumbbell eye capsule 2290 that fits loosely within the eye canal may be used to change the sound the eye capsule 2290 creates when the link fishing lure system is in use.

The link fishing lure systems of the present disclosure may include an enclosure with a channel and a connecting link. Any appropriate enclosure, channel, and/or connecting link may be utilized. In some implementations, the enclosure may include a weighting compartment that can removably house a weight. In some implementations, the enclosure may contain a weighting compartment that can irremovably house a weight. In some implementations, the enclosure may lack a weighting compartment and lack a weight. The enclosure may be shaped like a fish or part of a fish.

The channel can removably house the connecting link. The connecting link can slidably move within the channel. The channel has a shape and size that allows at least two ends of the connecting link to extend sufficiently outside the enclosure to couple at least one attachment. In some implementations, the channel may be shaped to allow the connecting link to be inserted in a single plane within the enclosure. In some implementations, the channel may be shaped to allow the connecting link to be inserted in one of multiple planes within the enclosure.

The connecting link has a length at least sufficiently greater than the channel to couple at least one attachment. The connecting link may have a length at least sufficiently greater than the channel to couple to at least one attachment when the geometry of the channel and the connecting link itself secures an end of the connecting link when one attachment is coupled to the other end of the connecting link. The connecting link may have a length at least sufficiently greater than the channel to couple to at least two attachment when the geometry of the channel and the connecting link itself cause the connecting link to be secure if two ends of the connecting link are secured. In some implementations, the connecting link may have an opening that allows at least one attachment to be coupled onto the connecting link by threading. In some implementations, the connecting link may have multiple openings that allow at least one attachment to be coupled onto the connecting link by threading. In some implementations, the connecting link may lack any openings. The ends of the connecting link are the areas of the connecting link that do not touch the enclosure when the connecting link is secure and that cause the connecting link to be secured within the enclosure when one or more attachments are connected to one or more parts of the connecting link. In some implementations, the connecting link may have one or more ends shaped like an open figure eight, rounded, squared off, shaped like a V, shaped like an M, or other form. The body of the connecting link may include segments that are substantially straight, curved, wavy, zig-zagged, or any similar form that extends along the length of the connecting link.

The connecting link is placed by the user within the channel inside of the enclosure. Based on the shapes and sizes of the connecting link and channel, one or more attachments may be coupled to the connecting link in order to secure the connecting link within the enclosure. The connecting link should be secure when the link fishing lure system is used while fishing because the link fishing lure system may otherwise disassemble.

In some implementations, the connecting link may be shaped so that any end can be inserted into any entrance of the channel in order to house the connecting link within the enclosure. When any end of the connecting link can fit into any opening of the channel, an attachment is coupled to both ends of the connecting link in order to secure the connecting link within the enclosure.

In some implementations, the connecting link may be shaped so that only one of the ends can be inserted into one of the entrances of the channel in order to house the connecting link within the enclosure. When such a relationship is present between the connecting link and the channel, one of the ends naturally secures the connecting link without coupling an attachment to that end when the other end is coupled to an attachment.

In some configurations, a fishing line that is tied in a knot is a clip-on attachment. In some configurations, a hook with a clip style eye is a clip-on attachment. The attachment may be a fishing line, a metal line, an offset worm hook, fly fishing lure, salt water streamer, feathered treble hook, flipping hook, vertical hook eye swim bait hook, horizontal hook eye weighted hook, weighted hook with coil keeper, skip gap hook, open eye hook, closed eye hook, open eye shaft with sleeve, monofilament line, braided line, duo lock snap, cross lock snap, coast lock snap, inline spinner bait wire forms, buzz bait wire forms, or other fishing attachment.

In some implementations, the link fishing lure systems of the present disclosure may further include an eye canal and an eye capsule. The eye capsule may have no rattles, a single rattle, or a plurality of rattles. The rattles within the eye capsule may differ in size and/or composition. The eye capsule may include a container with a cavity and with one or more walls positioned inside the container. The walls may be straight, angled, or curved. The walls may be solid or perforated. The walls may have openings sufficient to allow a rattle to pass through the wall. The eye capsule may be solid or hollow. The container of the eye capsule may be accessible to allow a user to reconfigure wall and/or rattle positioning. The dumbbell eye capsule may contain no walls, a single wall, or a plurality of walls. The dumbbell eye capsule may contain no rattles, a single rattle, or a plurality of rattles. Depending on the geometry and dimensions of the eye capsule and eye canal, it may be possible to insert the eye capsule from either one end or both ends of the eye canal. The eye capsule may have multiple cavities that, when at least one of the plurality of cavities is aligned with the channel, allow a connecting link to pass through the portion of the channel common to both the channel and eye canal.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a weight” includes a combination of two or more weights and reference to “an attachment” includes different types and/or combinations of attachments. Reference to a “weight compartment” may include a combination of two or weight compartments.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A fishing lure system, comprising:
a channel extending through an enclosure;
said channel operable to removably house a connecting link comprising a plurality of ends;
wherein said connecting link is secured within said enclosure when said connecting link is housed inside said channel and an attachment is coupled to at least one of said plurality of ends.

2. A fishing lure system, comprising:
an enclosure comprising a channel operable to house a connecting link;
wherein said connecting link is secured within said enclosure when an attachment is coupled to said connecting link.

3. A fishing lure system, comprising:
an enclosure with a channel extending through said enclosure; and
a means for connecting an attachment;
wherein said means for connecting is removably disposed within said channel.

4. The system of claim 1, further comprising:
a weighting compartment in said enclosure operable to house a weight.

5. The system of claim 1 wherein said connecting link is shaped like an open geometric stadium.

6. The system of claim 1 wherein said connecting link has at least one end shaped like an open figure eight.

7. The system of claim 1 wherein said connecting link has an opening.

8. The system of claim 1 wherein said enclosure is shaped like part of a fish.

9. The system of claim 1 wherein said connecting link is slidably moveable within said channel.

10. The system of claim 2, further comprising:
a weighting compartment operable to house a weight in said enclosure.

11. The system of claim 2 wherein said connecting link is slidably moveable within said channel.

12. The system of claim 2 wherein said enclosure is shaped like part of a fish.

13. The system of claim 2 wherein said connecting link has an opening.

14. The system of claim 2 wherein said connecting link is shaped like an open geometric stadium.

15. The system of claim 2 wherein said connecting link has at least one end shaped like an open figure eight.

16. The system of claim 3, further comprising:
a weighting compartment operable to house a weight in said enclosure.

17. The system of claim 3 wherein said means for connecting is slidably moveable within said channel.

18. The system of claim 1, further comprising:
an eye canal extending through said enclosure and intersecting said channel, wherein said eye canal is operable to house an eye capsule.

19. The system of claim 2, further comprising:
an eye canal extending through said enclosure and intersecting said channel, wherein said eye canal is operable to house an eye capsule;
wherein said eye capsule is secured within said eye canal when said connecting link is inserted into said channel and then secured within said enclosure.

20. A system of claim 3, further comprising:
a means for producing a sound when the system is in use.
